(19) United States
(12) Patent Application Publication
(10) Pub. No.: US 2016/0333220 A1
(43) Pub. Date: Nov. 17, 2016

(54) CURABLE FILM-FORMING COMPOSITIONS CONTAINING PHOTOTHERMALLY ACTIVE MATERIALS, COATED METAL SUBSTRATES, AND METHODS OF COATING SUBSTRATES

(71) Applicant: PPG INDUSTRIES OHIO, INC., CLEVELAND, OH (US)

(72) Inventors: DAVID WALTERS, SLIPPERY ROCK, PA (US); MICHAEL PAUL MAKOWSKI, ALLISON PARK, PA (US); STEPHEN JOHN THOMAS, ASPINWALL, PA (US); MICHAEL ANDREW ZALICH, PITTSBURGH, PA (US); KAITLIN HAAS, STATE COLLEGE, PA (US); BENJAMIN LEAR, STATE COLLEGE, PA (US); DANIEL RARDON, PITTSBURGH, PA (US)

(21) Appl. No.: 15/143,647

(22) Filed: May 2, 2016

Related U.S. Application Data
(60) Provisional application No. 62/159,384, filed on May 11, 2015.

(51) Int. Cl. C09D 175/06; B05D 3/00

(52) U.S. Cl. CPC C09D 175/06; B05D 3/007; C08K 9/04

(57) ABSTRACT

A curable film-forming composition is provided, comprising:
(a) a curing agent comprising reactive functional groups;
(b) a compound comprising functional groups reactive with the reactive functional groups in (a); and
(c) a photothermally active material. The composition may further include a catalyst component. Coated substrates are also provided using the compositions described, as well as methods for coating a substrate using the compositions.

### CROSS-REFERENCE TO RELATED APPLICATION

This application claims priority from provisional U.S. Patent Application Ser. No. 62/159,384, filed May 11, 2015, and entitled “CURABLE FILM-FORMING COMPOSITIONS CONTAINING PHOTOTHERMALLY ACTIVE MATERIALS, COATED METAL SUBSTRATES, AND METHODS OF COATING SUBSTRATES”, which is incorporated herein by reference in its entirety.

### FIELD OF THE INVENTION

The present invention relates to curable film-forming compositions that comprise photothermally active materials. The present invention also relates to substrates at least partially coated with a coating deposited from such a composition and methods of coating substrates with these compositions.

### BACKGROUND OF THE INVENTION

The vehicle coating industries, in particular, industrial coatings, aerospace coatings, the automotive after-market and refinish coating industries, have demonstrated a desire for cure-on-demand products; i.e., coating products that are formulated and have an extended, even indefinite, shelf life but that may be applied to a substrate and cured at any time with little or no preparation.

It would be desirable to provide a curable film-forming composition which demonstrates an extended shelf life and can be cured after application to a substrate with a simple stimulus to activate cure chemistries.

### SUMMARY OF THE INVENTION

The present invention provides a curable film-forming, or coating, composition comprising:

(a) a curing agent having reactive functional groups and comprising a polyisocyanate, beta-hydroxyalkylamide, polyacid, organometallic acid-functional material, polyamine, polyamide, polysulfide, polythiol, polyene, polyol, polysilane and/or an aminoplast;

(b) a compound having functional groups reactive with the reactive functional groups in (a) and comprising an addition polymer, a polyether polymer, a polyester polymer, a polyester acrylate polymer, a polyurethane polymer, and/or a polyurethane acrylate polymer.; and

(c) a photothermally active material.

The present invention also provides a curable film-forming, or coating, composition comprising:

(a) a curing agent comprising reactive functional groups;

(b) a compound having functional groups reactive with the reactive functional groups in (a);

(c) a photothermally active material; and

(d) a catalyst component.

Additionally provided are substrates at least partially coated with either of the curable film-forming compositions described above.

Also provided are methods of coating a substrate, comprising:
(1) applying to at least one surface of the substrate a curable film-forming composition to form a coated substrate, wherein the curable film-forming composition comprises either of the compositions described above; and
(2) irradiating the coated substrate with pulsed actinic radiation at a wavelength, duration, and intensity sufficient to at least partially cure the curable film-forming composition.

### DETAILED DESCRIPTION

Other than in the operating examples, or unless otherwise expressly specified, all of the numerical ranges, amounts, values and percentages such as those for amounts of materials, times and temperatures of reaction, ratios of amounts, values for molecular weight (whether number average molecular weight (“Mₙ”) or weight average molecular weight (“M_{w}”)), and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Plural referents as used herein encompass singular and vice versa. For example, while the invention has been described in terms of “a” cationic acrylic resin derived from an epoxy functional acrylic resin, a plurality, including a mixture of such resins can be used.

Any numeric references to amounts, unless otherwise specified, are “by weight”. The term “equivalent weight” is a calculated value based on the relative amounts of the various ingredients used in making the specified material and is based on the solids of the specified material. The relative amounts are those that result in the theoretical weight in grams of the material, like a polymer, produced from the ingredients and give a theoretical number of the particular functional group that is present in the resulting polymer. The theoretical polymer weight is divided by the theoretical number of equivalents of functional groups to give the equivalent weight. For example, urethane equivalent weight is based on the equivalents of urethane groups in the polyurethane material.

As used herein, the term “polymer” is meant to refer to prepolymers, oligomers and both homopolymers and copolymers; the prefix “poly” refers to two or more.

Also for molecular weights, whether number average (Mₙ) or weight average (M_{w}), these quantities are determined by gel permeation chromatography using polystyrene as standards as is well known to those skilled in the art and such as is discussed in U.S. Pat. No. 4,739,019, at column 4, lines 2-45.

As used herein “based on the total weight of resin solids” or “based on the total weight of organic binder solids” (used interchangeably) of the composition means that the amount of the component added during the formation of the composition is based upon the total weight of the resin solids (non-volatiles) of the film forming materials, including cross-linkers and polymers present during the formation of the composition, but not including any water, solvent, or any additive solids such as hindered amine stabilizers, photoinitiators, pigments including extender pigments and fillers, flow modifiers, catalysts, and UV light absorbers.

As used herein, the terms “thermosetting” and “curable” can be used interchangeably and refer to resins that “set” irreversibly upon curing or crosslinking, wherein the polymer chains of the polymeric components are joined together by covalent bonds. This property is usually associated with a crosslinking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Curing or crosslinking reactions also may be carried out under ambient conditions. By ambient conditions is meant that the coating undergoes a thermosetting reaction without the aid of heat or other energy, for example, without baking in an oven, use of forced air, or the like. Usually ambient temperature ranges from 60 to 90° F. (15.6 to 32.2° C.), such as a typical room temperature, 72° F. (22.2° C.). Once cured or crosslinked, a thermosetting resin will not melt upon the application of heat and is insoluble in solvents.

“Actinic radiation” is light with wavelengths of electromagnetic radiation ranging from the ultraviolet (“UV”) light range, through the visible light range, and into the infrared range.

The curable film-forming compositions of the present invention may be essentially free of certain materials. By “essentially free” is meant that these materials are not essential to the composition and hence the curable film-forming composition is free of these materials in any appreciable or essential amount. If they are present, it is in incidental amounts only, typically less than 0.1 percent by weight, based on the total weight of solids in the curable film-forming composition.

The curable film-forming compositions of the present invention may be solventborne or waterborne. The curable compositions comprise (a) a curing agent component having reactive functional groups; (b) a compound comprising functional groups that are reactive with the reactive functional groups in the curing agent (a); and (c) a photothermally active material.

Suitable curing agents, or crosslinking agents, (a) for use in the curable film-forming compositions of the present invention include aminoplasts, polyisocyanates, including blocked isocyanates, polyepoxides, beta-hydroxyalkylamides, polyacids, including anhydrides and polyanhydrides, organometallic acid-functional materials, polyamines, polyamides, polysulfides, polythiols, polyenes such as polyacrylates, polyols, polysilanes and mixtures of any of the foregoing, and include those known in the art for any of these materials.

Useful aminoplasts can be obtained from the condensation reaction of formaldehyde with an amine or amide. Nonlimiting examples of amines or amides include melamine, urea and benzoguanamine.

Although condensation products obtained from the reaction of alcohols and formaldehyde with melamine, urea or benzoguanamine are most common, condensates with other amines or amides can be used. Formaldehyde is the most commonly used aldehyde, but other aldehydes such as acetaldehyde, crotonaldehyde, and benzaldehyde can also be used.

The aminoplast can contain imino and methylol groups. In certain instances, at least a portion of the methylol groups can be etherified with an alcohol to modify the cure response. Any monohydric alcohol like methanol, ethanol, n-butyl alcohol, isobutanol, and hexanol can be employed for this purpose. Nonlimiting examples of suitable aminoplast resins are commercially available from Cytec Industries, Inc. under the trademark CYMEL® and from Solutia, Inc. under the trademark RESIMENE®.

Other crosslinking agents suitable for use include polyisocyanate crosslinking agents. As used herein, the term “polyisocyanate” is intended to include blocked (or capped) polyisocyanates as well as unblocked polyisocyanates. The polyisocyanate can be aliphatic, aromatic, or a mixture thereof. Although higher polyisocyanates such as isocyanurates of diisocyanates are often used, diisocyanates can also be used. Isocyanate prepolymers, for example reaction products of polyisocyanates with polyols also can be used. Mixtures of polyisocyanate crosslinking agents can be used.

The polyisocyanate can be prepared from a variety of isocyanate-containing materials. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used.

Isocyanate groups may be capped or uncapped as desired. If the polyisocyanate is to be blocked or capped, any suitable aliphatic, cycloaliphatic, or aromatic alkyl monoalcohol or phenolic compound known to those skilled in the art can be used as a capping agent for the polyisocyanate. Examples of suitable blocking agents include those materials which would unblock at elevated temperatures such as lower aliphatic alcohols including methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether. Other suitable capping agents include oximes such as methyl ethyl ketoxime, acetone oxime and cyclohexanone oxime, lactams such as epsilon-caprolactam, pyrazoles such as dimethyl pyrazole, and amines such as dibutyl amine.

Polyepoxides are suitable curing agents for polymers having carboxylic acid groups and/or amine groups. Examples of suitable polyepoxides include low molecular weight polyepoxides such as 3,4-epoxycyclohexylmethyl 3,4-epoxycyclohexanecarboxylate and bis(3,4-epoxy-6-methylcyclohexyl-methyl) adipate. Higher molecular weight polyepoxides, including the polyglycidyl ethers of polyhydric phenols and alcohols described below, are also suitable as crosslinking agents.

Beta-hydroxyalkylamides are suitable curing agents for polymers having carboxylic acid groups. The beta-hydroxyalkylamides can be depicted structurally as follows:

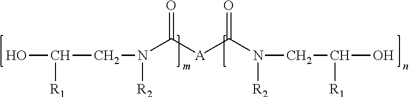

wherein R₁ is H or C₁ to C₅ alkyl; R₂ is H, C₁ to C₅ alkyl, or:

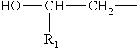

wherein R₁ is as described above; A is a bond or a polyvalent organic radical derived from a saturated, unsaturated, or aromatic hydrocarbon including substituted hydrocarbon radicals containing from 2 to 20 carbon atoms; m is equal to 1 or 2; n is equal to 0 or 2, and m+n is at least 2, usually within the range of from 2 up to and including 4. Most often, A is a C₂ to C₁₂ divalent alkylene radical.

Polyacids, particularly polycarboxylic acids, are suitable curing agents for polymers having epoxy functional groups. Examples of suitable polycarboxylic acids include adipic, succinic, sebacic, azelaic, and dodecanedioic acid. Other suitable polyacid crosslinking agents include acid group-containing acrylic polymers prepared from an ethylenically unsaturated monomer containing at least one carboxylic acid group and at least one ethylenically unsaturated monomer that is free from carboxylic acid groups. Such acid functional acrylic polymers can have an acid number ranging from 30 to 150. Acid functional group-containing polyesters can be used as well. Low molecular weight polyesters and half-acid esters can be used which are based on the condensation of aliphatic polyols with aliphatic and/or aromatic polycarboxylic acids or anhydrides. Examples of suitable aliphatic polyols include ethylene glycol, propylene glycol, butylene glycol, 1,6-hexanediol, trimethylol propane, di-trimethylol propane, neopentyl glycol, 1,4-cyclohexanedimethanol, pentaerythritol, and the like. The polycarboxylic acids and anhydrides may include, inter alia, terephthalic acid, isophthalic acid, phthalic acid, phthalic anhydride, tetrahydrophthalic acid, tetrahydrophthalic anhydride, hexahydrophthalic anhydride, methylhexahydrophthalic anhydride, chlorendic anhydride, and the like. Mixtures of acids and/or anhydrides may also be used. The above-described polyacid crosslinking agents are described in further detail in U.S. Pat. No. 4,681,811, at column 6, line 45 to column 9, line 54, which is incorporated herein by reference.

Nonlimiting examples of suitable polyamine crosslinking agents include primary or secondary diamines or polyamines in which the radicals attached to the nitrogen atoms can be saturated or unsaturated, aliphatic, alicyclic, aromatic, aromatic-substituted-aliphatic, aliphatic-substituted-aromatic, and heterocyclic. Nonlimiting examples of suitable aliphatic and alicyclic diamines include 1,2-ethylene diamine, 1,2-propylene diamine, 1,8-octane diamine, isophorone diamine, propane-2,2-cyclohexyl amine, and the like. Nonlimiting examples of suitable aromatic diamines include phenylene diamines and toluene diamines, for example o-phenylene diamine and p-tolylene diamine. Polynuclear aromatic diamines such as 4,4′-biphenyl diamine, methylene dianiline and monochloromethylene dianiline are also suitable.

Examples of suitable aliphatic diamines include, without limitation, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof. Cycloaliphatic diamines are available commercially from Huntsman Corporation (Houston, Tex.) under the designation of JEFFLINK™ such as JEFFLINK™ 754. Additional aliphatic cyclic polyamines may also be used, such as DESMOPHEN NH 1520 available from Bayer MaterialScience and/or CLEARLINK 1000, which is a secondary aliphatic diamine available from Dorf Ketal. POLYCLEAR 136 (available from BASF/Hansen Group LLC), the reaction product of isophorone diamine and acrylonitrile, is also suitable. Other exemplary suitable polyamines are described in U.S. Pat. No. 4,046,729 at column 6, line 61 to column 7, line 26, and in U.S. Pat. No. 3,799,854 at column 3, lines 13 to 50, the cited portions of which are incorporated by reference herein. Additional polyamines may also be used, such as ANCAMINE polyamines, available from Air Products and Chemicals, Inc.

Suitable polyamides include any of those known in the art. For example, ANCAMIDE polyamides, available from Air Products and Chemicals, Inc.

Suitable polyenes may include those that are represented by the formula:

A-(X)ₘ

wherein A is an organic moiety, X is an olefinically unsaturated moiety and m is at least 2, typically 2 to 6. Examples of X are groups of the following structure:

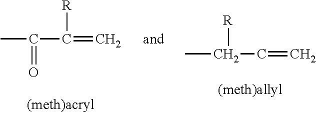

wherein each R is a radical selected from H and methyl.

The polyenes may be compounds or polymers having in the molecule olefinic double bonds that are polymerizable by exposure to radiation. Examples of such materials are (meth)acrylic-functional (meth)acrylic copolymers, epoxy resin (meth)acrylates, polyester (meth)acrylates, polyether (meth)acrylates, polyurethane (meth)acrylates, amino (meth)acrylates, silicone (meth)acrylates, and melamine (meth)acrylates. The number average molar mass (Mn) of these compounds is often around 200 to 10,000. The molecule often contains on average 2 to 20 olefinic double bonds that are polymerizable by exposure to radiation. Aliphatic and/or cycloaliphatic (meth)acrylates in each case are often used. (Cyclo)aliphatic polyurethane (meth)acrylates and (cyclo)aliphatic polyester (meth)acrylates are particularly suitable. The binders may be used singly or in mixture.

Specific examples of polyurethane (meth)acrylates are reaction products of the polyisocyanates such as 1,6-hexamethylene diisocyanate and/or isophorone diisocyanate including isocyanurate and biuret derivatives thereof with hydroxyalkyl (meth)acrylates such as hydroxyethyl (meth)acrylate and/or hydroxypropyl (meth)acrylate. The polyisocyanate can be reacted with the hydroxyalkyl (meth)acrylate in a 1:1 equivalent ratio or can be reacted with an NCO/OH equivalent ratio greater than 1 to form an NCO-containing reaction product that can then be chain extended with a polyol such as a diol or triol, for example 1,4-butane diol, 1,6-hexane diol and/or trimethylol propane. Examples of polyester (meth)acrylates are the reaction products of (meth)acrylic acid or anhydride with polyols, such as diols, triols and tetrols, including alkylated polyols, such as propoxylated diols and triols. Examples of polyols include 1,4-butane diol, 1,6-hexane diol, neopentyl glycol, trimethylol propane, pentaerythritol and propoxylated 1,6-hexane diol. Specific examples of polyester (meth)acrylate are glycerol tri(meth)acrylate, trimethylolpropane tri(meth)acrylate, pentaerythritol tri(meth)acrylate and pentaerythritol tetra(meth)acrylate.

Besides (meth)acrylates, (meth)allyl compounds or polymers can be used either alone or in combination with (meth)acrylates. Examples of (meth)allyl materials are polyalkyl ethers such as the diallyl ether of 1,4-butane diol and the triallyl ether of trimethylol propane. Examples of other (meth)allyl materials are polyurethanes containing (meth)allyl groups. For example, reaction products of the polyisocyanates such as 1,6-hexamethylene diisocyanate and/or isophorone diisocyanate including isocyanurate and biuret derivatives thereof with hydroxyl-functional allyl ethers, such as the monoallyl ether of 1,4-butane diol and the diallylether of trimethylol propane. The polyisocyanate can be reacted with the hydroxyl-functional allyl ether in a 1:1 equivalent ratio or can be reacted with an NCO/OH equivalent ratio greater than 1 to form an NCO-containing reaction product that can then be chain extended with a polyol such as a diol or triol, for example 1,4-butane diol, 1,6-hexane diol and/or trimethylol propane.

As used herein the term “polythiol functional material” refers to polyfunctional materials containing two or more thiol functional groups (SH). Suitable polythiol functional materials for use in forming the curable film-forming composition are numerous and can vary widely. Such polythiol functional materials can include those that are known in the art. Non-limiting examples of suitable polythiol functional materials can include polythiols having at least two thiol groups including compounds and polymers. The polythiol can have ether linkages (—O—), sulfide linkages (—S—), including polysulfide linkages (—Sₓ), wherein x is at least 2, such as from 2 to 4, and combinations of such linkages.

The polythiols for use in the present invention include materials of the formula:

R¹—(SH)ₙ

wherein R¹ is a polyvalent organic moiety and n is an integer of at least 2, typically 2 to 6.

Non-limiting examples of suitable polythiols include esters of thiol-containing acids of the formula HS—R²—COOH wherein R² is an organic moiety with polyhydroxy compounds of the structure R³—(OH)ₙ wherein R³ is an organic moiety and n is at least 2, typically 2 to 6. These components can be reacted under suitable conditions to give polythiols having the general structure:

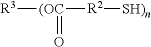

wherein R², R³ and n are as defined above.

Examples of thiol-containing acids are thioglycolic acid (HS—CH₂COOH), α-mercaptopropionic acid (HS—CH(CH₃)—COOH) and β-mercaptopropionic acid (HS—CH₂CH₂COOH) with polyhydroxy compounds such as glycols, triols, tetrols, pentaols, hexaols, and mixtures thereof. Other non-limiting examples of suitable polythiols include ethylene glycol bis (thioglycolate), ethylene glycol bis(β-mercaptopropionate), trimethylolpropane tris (thioglycolate), trimethylolpropane tris (β-mercaptopropionate), pentaerythritol tetrakis (thioglycolate) and pentaerythritol tetrakis (β-mercaptopropionate), and mixtures thereof.

Suitable polyacids and polyols useful as curing agents include any of those known in the art, such as those described herein for the making of polyesters.

Appropriate mixtures of crosslinking agents may also be used in the invention. The amount of the crosslinking agent in the curable film-forming composition generally ranges from 5 to 75 percent by weight based on the total weight of resin solids in the curable film-forming composition. For example, the minimum amount of crosslinking agent may be at least 5 percent by weight, often at least 10 percent by weight and more often, at least 15 percent by weight. The maximum amount of crosslinking agent may be 75 percent by weight, more often 60 percent by weight, or 50 percent by weight. Ranges of crosslinking agent may include, for example, 5 to 50 percent by weight, 5 to 60 percent by weight, 10 to 50 percent by weight, 10 to 60 percent by weight, 10 to 75 percent by weight, 15 to 50 percent by weight, 15 to 60 percent by weight, and 15 to 75 percent by weight.

The compound (b) having functional groups reactive with the reactive functional groups on the curing agent (a) is a film-forming compound, often a resin, and may be selected from one or more of: addition polymers such as acrylic polymers, polyesters including polyester acrylates, polyurethanes including polyurethane acrylates, polyamides, polyethers, polythioethers, polythioesters, polythiols, polyenes, polyols, polysilanes, polysiloxanes, fluoropolymers, polycarbonates, and epoxy resins. Generally these compounds, which need not be polymeric, can be made by any method known to those skilled in the art where the compounds are water dispersible, emulsifiable, or of limited water solubility as understood in the art. The functional groups on the film-forming binder may be selected from at least one of carboxylic acid groups, amine groups, epoxide groups, hydroxyl groups, thiol groups, carbamate groups, amide groups, urea groups, (meth)acrylate groups, styrenic groups, vinyl groups, allyl groups, aldehyde groups, acetoacetate groups, hydrazide groups, cyclic carbonate, acrylate, maleic and mercaptan groups. The functional groups on the compound (b) are selected so as to be reactive with those on the curing agent (a).

Suitable acrylic compounds include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and often 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The acrylic copolymer can include hydroxyl functional groups, which are often incorporated into the polymer by including one or more hydroxyl functional monomers in the reactants used to produce the copolymer. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates, as well as the beta-hydroxy ester functional monomers described below. The acrylic polymer can also be prepared with N-(alkoxymethyl)acrylamides and N-(alkoxymethyl) methacrylamides.

Beta-hydroxy ester functional monomers can be prepared from ethylenically unsaturated, epoxy functional monomers and carboxylic acids having from about 13 to about 20 carbon atoms, or from ethylenically unsaturated acid functional monomers and epoxy compounds containing at least 5 carbon atoms which are not polymerizable with the ethylenically unsaturated acid functional monomer.

Useful ethylenically unsaturated, epoxy functional monomers used to prepare the beta-hydroxy ester functional monomers include glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. (Note: these epoxy functional monomers may also be used to prepare epoxy functional acrylic polymers.) Examples of carboxylic acids include saturated monocarboxylic acids such as isostearic acid and aromatic unsaturated carboxylic acids.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate. The ethylenically unsaturated acid functional monomer and epoxy compound are typically reacted in a 1:1 equivalent ratio. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, often containing from 8 to 30 carbon atoms, such as butyl glycidyl ether, octyl glycidyl ether, phenyl glycidyl ether and para-(tertiary butyl) phenyl glycidyl ether. Particular glycidyl esters include those of the structure:

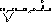

where R is a hydrocarbon radical containing from about 4 to about 26 carbon atoms. Typically, R is a branched hydrocarbon group having from about 8 to about 10 carbon atoms, such as neopentanoate, neoheptanoate or neodecanoate. Suitable glycidyl esters of carboxylic acids include VERSATIC ACID 911 and CARDURA E, each of which is commercially available from Shell Chemical Co.

Carbamate functional groups can be included in the acrylic polymer by copolymerizing the acrylic monomers with a carbamate functional vinyl monomer, such as a carbamate functional alkyl ester of methacrylic acid, or by reacting a hydroxyl functional acrylic polymer with a low molecular weight carbamate functional material, such as can be derived from an alcohol or glycol ether, via a transcarbamoylation reaction. Alternatively, carbamate functionality may be introduced into the acrylic polymer by reacting a hydroxyl functional acrylic polymer with a low molecular weight carbamate functional material, such as can be derived from an alcohol or glycol ether, via a transcarbamoylation reaction. In this reaction, a low molecular weight carbamate functional material derived from an alcohol or glycol ether is reacted with the hydroxyl groups of the acrylic polyol, yielding a carbamate functional acrylic polymer and the original alcohol or glycol ether. The low molecular weight carbamate functional material derived from an alcohol or glycol ether may be prepared by reacting the alcohol or glycol ether with urea in the presence of a catalyst. Suitable alcohols include lower molecular weight aliphatic, cycloaliphatic, and aromatic alcohols such as methanol, ethanol, propanol, butanol, cyclohexanol, 2-ethylhexanol, and 3-methylbutanol. Suitable glycol ethers include ethylene glycol methyl ether and propylene glycol methyl ether. Propylene glycol methyl ether and methanol are most often used. Other carbamate functional monomers as known to those skilled in the art may also be used.

Amide functionality may be introduced to the acrylic polymer by using suitably functional monomers in the preparation of the polymer, or by converting other functional groups to amido-groups using techniques known to those skilled in the art. Likewise, other functional groups may be incorporated as desired using suitably functional monomers if available or conversion reactions as necessary.

Acrylic polymers can be prepared via aqueous emulsion polymerization techniques and used directly in the preparation of aqueous coating compositions, or can be prepared via organic solution polymerization techniques for solventborne compositions. When prepared via organic solution polymerization with groups capable of salt formation such as acid or amine groups, upon neutralization of these groups with a base or acid the polymers can be dispersed into aqueous medium. Generally any method of producing such polymers that is known to those skilled in the art utilizing art recognized amounts of monomers can be used.

Besides acrylic polymers, the compound (b) in the curable film-forming composition may be an alkyd resin or a polyester. Such polymers may be prepared in a known manner by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane, and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used. Where it is desired to produce air-drying alkyd resins, suitable drying oil fatty acids may be used and include, for example, those derived from linseed oil, soya bean oil, tall oil, dehydrated castor oil, or tung oil.

Likewise, polyamides may be prepared utilizing polyacids and polyamines. Suitable polyacids include those listed above and polyamines may be selected from at least one of ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane.

Carbamate functional groups may be incorporated into the polyester or polyamide by first forming a hydroxyalkyl carbamate which can be reacted with the polyacids and polyols/polyamines used in forming the polyester or polyamide. The hydroxyalkyl carbamate is condensed with acid functionality on the polymer, yielding terminal carbamate functionality. Carbamate functional groups may also be incorporated into the polyester by reacting terminal hydroxyl groups on the polyester with a low molecular weight carbamate functional material via a transcarbamoylation process similar to the one described above in connection with the incorporation of carbamate groups into the acrylic polymers, or by reacting isocyanic acid with a hydroxyl functional polyester.

Other functional groups such as amine, amide, thiol, urea, or others listed above may be incorporated into the polyamide, polyester or alkyd resin as desired using suitably functional reactants if available, or conversion reactions as necessary to yield the desired functional groups. Such techniques are known to those skilled in the art.

Polyurethanes can also be used as the compound (b) in the curable film-forming composition. Among the polyurethanes which can be used are polymeric polyols which generally are prepared by reacting the polyester polyols or acrylic polyols such as those mentioned above with a polyisocyanate such that the OH/NCO equivalent ratio is greater than 1:1 so that free hydroxyl groups are present in the product. The organic polyisocyanate which is used to prepare the polyurethane polyol can be an aliphatic or an aromatic polyisocyanate or a mixture of the two. Diisocyanates are typically used, although higher polyisocyanates can be used in place of or in combination with diisocyanates. Examples of suitable aromatic diisocyanates are 4,4′-diphenylmethane diisocyanate and toluene diisocyanate. Examples of suitable aliphatic diisocyanates are straight chain aliphatic diisocyanates such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates are 1,2,4-benzene triisocyanate polymethylene polyphenyl isocyanate, and isocyanate trimers based on 1,6-hexamethylene diisocyanate or isophorone diisocyanate. As with the polyesters, the polyurethanes can be prepared with unreacted carboxylic acid groups, which upon neutralization with bases such as amines allows for dispersion into aqueous medium.

Terminal and/or pendent carbamate functional groups can be incorporated into the polyurethane by reacting a polyisocyanate with a polymeric polyol containing the terminal/pendent carbamate groups. Alternatively, carbamate functional groups can be incorporated into the polyurethane by reacting a polyisocyanate with a polyol and a hydroxyalkyl carbamate or isocyanic acid as separate reactants. Carbamate functional groups can also be incorporated into the polyurethane by reacting a hydroxyl functional polyurethane with a low molecular weight carbamate functional material via a transcarbamoylation process similar to the one described above in connection with the incorporation of carbamate groups into the acrylic polymer. Additionally, an isocyanate functional polyurethane can be reacted with a hydroxyalkyl carbamate to yield a carbamate functional polyurethane.

Other functional groups such as amide, thiol, urea, or others listed above may be incorporated into the polyurethane as desired using suitably functional reactants if available, or conversion reactions as necessary to yield the desired functional groups. Such techniques are known to those skilled in the art.

Examples of polyether polyols are polyalkylene ether polyols which include those having the following structural formula:

(i)

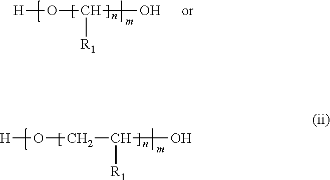

where the substituent R₁ is hydrogen or lower alkyl containing from 1 to 5 carbon atoms including mixed substituents, and n is typically from 2 to 6 and m is from 8 to 100 or higher. Included are poly(oxytetramethylene) glycols, poly(oxytetraethylene) glycols, poly(oxy-1,2-propylene) glycols, and poly(oxy-1,2-butylene) glycols.

Also useful are polyether polyols formed from oxyalkylation of various polyols, for example, diols such as ethylene glycol, 1,6-hexanediol, Bisphenol A and the like, or other higher polyols such as trimethylolpropane, pentaerythritol, and the like. Polyols of higher functionality which can be utilized as indicated can be made, for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Particular polyethers include those sold under the names TERATHANE and TERACOL, available from Invista, and POLYMEG, available from Lyondell Chemical Co.

Pendant carbamate functional groups may be incorporated into the polyethers by a transcarbamoylation reaction. Other functional groups such as acid, amine, epoxide, amide, thiol, and urea may be incorporated into the polyether as desired using suitably functional reactants if available, or conversion reactions as necessary to yield the desired functional groups. Examples of suitable amine functional polyethers include those sold under the name JEFFAMINE, such as JEFFAMINE D2000, a polyether functional diamine available from Huntsman Corporation.

Suitable epoxy functional polymers for use as the compound (b) may include a polyepoxide chain extended by reacting together a polyepoxide and a polyhydroxyl group-containing material selected from alcoholic hydroxyl group-containing materials and phenolic hydroxyl group-containing materials to chain extend or build the molecular weight of the polyepoxide.

A chain extended polyepoxide is typically prepared by reacting together the polyepoxide and polyhydroxyl group-containing material neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction is usually conducted at a temperature of about 80° C. to 160° C. for about 30 to 180 minutes until an epoxy group-containing resinous reaction product is obtained.

The equivalent ratio of reactants; i.e., epoxy:polyhydroxyl group-containing material is typically from about 1.00:0.75 to 1.00:2.00.

The polyepoxide by definition has at least two 1,2-epoxy groups. In general the epoxide equivalent weight of the polyepoxide will range from 100 to about 2000, typically from about 180 to 500. The epoxy compounds may be saturated or unsaturated, cyclic or acyclic, aliphatic, alicyclic, aromatic or heterocyclic. They may contain substituents such as halogen, hydroxyl, and ether groups.

Examples of polyepoxides are those having a 1,2-epoxy equivalency greater than one and usually about two; that is, polyepoxides which have on average two epoxide groups per molecule. The most commonly used polyepoxides are polyglycidyl ethers of cyclic polyols, for example, polyglycidyl ethers of polyhydric phenols such as Bisphenol A, resorcinol, hydroquinone, benzenedimethanol, phloroglucinol, and catechol; or polyglycidyl ethers of polyhydric alcohols such as alicyclic polyols, particularly cycloaliphatic polyols such as 1,2-cyclohexane diol, 1,4-cyclohexane diol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tertiarybutylcyclohexyl)propane, 1,3-bis(hydroxymethyl)cyclohexane and 1,2-bis(hydroxymethyl)cyclohexane. Examples of aliphatic polyols include, inter alia, trimethylpentanediol and neopentyl glycol.

Polyhydroxyl group-containing materials used to chain extend or increase the molecular weight of the polyepoxide may additionally be polymeric polyols such as any of those disclosed above. The present invention may comprise epoxy resins such as diglycidyl ethers of Bisphenol A, Bisphenol F, glycerol, novolacs, and the like. Exemplary suitable polyepoxides are described in U.S. Pat. No. 4,681,811 at column 5, lines 33 to 58, the cited portion of which is incorporated by reference herein.

Epoxy functional film-forming polymers may alternatively be acrylic polymers prepared with epoxy functional monomers such as glycidyl acrylate, glycidyl methacrylate, allyl glycidyl ether, and methallyl glycidyl ether. Polyesters, polyurethanes, or polyamides prepared with glycidyl alcohols or glycidyl amines, or reacted with an epihalohydrin are also suitable epoxy functional resins. Epoxide functional groups may be incorporated into a resin by reacting hydroxyl groups on the resin with an epihalohydrin or dihalohydrin such as epichlorohydrin or dichlorohydrin in the presence of alkali.

Nonlimiting examples of suitable fluoropolymers include fluoroethylene-alkyl vinyl ether alternating copolymers (such as those described in U.S. Pat. No. 4,345,057) available from Asahi Glass Company under the name LUMIFLON; fluoroaliphatic polymeric esters commercially available from 3M of St. Paul, Minn. under the name FLUORAD; and perfluorinated hydroxyl functional (meth)acrylate resins.

The composition of the present invention further comprises (c) a photothermally active material. Photothermally active materials generate heat upon exposure to actinic radiation, typically due to strong light absorption properties coupled with weak light emission properties, giving rise to a strong photothermal effect. Examples of photothermally active materials include silver, gold, aluminum, copper, titanium, chromium, magnetite, Si, Ge, Sn, GaAs, CdSe, AlGaAs, Fe4[Fe(CN)6]3, Cu-phthalocyanine, HgS, a metal oxide, carbon, an organic dye, polythiophene, polyacetylene, and/or polyaniline.

When the composition of the present invention is exposed to actinic radiation, sufficient heat is generated by the photothermally active material to effect cure of the curable composition. The heat generated by the photothermally active material enables the formation of a bond between reactive functional groups. For example, gold silver, and aluminum exhibit surface plasmon resonance when irradiated with light in a known range of wavelengths and intensities, causing a transient and localized (on a molecular scale) generation of heat that promotes chemical reaction between the functional groups on the other components of the curable film-forming composition. In materials demonstrating surface plasmon resonance, the origin of photothermal heat is absorption of light by the surface plasmon resonance (SPR) of the metal particles, which excites a collective oscillation of electrons that quickly (femtoseconds) dephase, transferring energy as heat. The system reaches peak temperature on the picosecond timescale, and then transfers thermal energy away from the particles, elevating the temperature of the local molecular environment, but leaving the bulk temperature of the composition largely unperturbed. The rapid cooling of the particles provides a possible means for retaining species transiently generated (i.e., the crosslinked coating) at high temperatures. In other words, there is no time for the reaction to reverse itself because the heat is dissipated.

For example, it has been found that that the photothermal effect of plasmonic gold nanoparticles cures urethane films at a rate that competes with the action of traditional molecular catalysts. This is surprising, as the formation of urethane is both exothermic, and reversible at high temperatures—both of which would prevent urethane formation if the photothermal effect were not transient. In fact, when the transient nature of the photothermal effect is accounted for, the actual rate enhancements are on the order of 10⁹.

A photothermally active material of any average particle size can be used according to the present invention, provided it generates sufficient heat for curing to take place when the curable film-forming composition is exposed to actinic radiation. For example, the photothermally active material may be micron sized, such as 0.5 to 50 microns or 1 to 15 microns, with size based on average particle size. Alternatively, the photothermally active material may be nano sized, such as 10 to 499 nanometers, or 10 to 100 nanometers, with size based on average particle size. It will be appreciated that these particle sizes refer to the particle size of the photothermally active material at the time of incorporation into the curable film-forming composition. Various coating preparation methods may result in the particles agglomerating, which could increase average particle size, or shearing or other action that can reduce average particle size. Thus the photothermally active material (c) may be present in the form of particles such as microparticles and/or nanoparticles such as nanowires, nanorods, nanoplatlets, nanospheres and irregularly shaped particles of appropriate size.

Often the particles of photothermally active material have an average primary particle size of no more than 500 nanometers, such as no more than 50 nanometers, or no more than 2 nanometers, as determined by visually examining a micrograph of a transmission electron microscopy (“TEM”) image, measuring the diameter of the particles in the image, and calculating the average primary particle size of the measured particles based on magnification of the TEM image. One of ordinary skill in the art will understand how to prepare such a TEM image and determine the primary particle size based on the magnification. The primary particle size of a particle refers to the smallest diameter sphere that will completely enclose the particle. As used herein, the term “primary particle size” refers to the size of an individual particle as opposed to an agglomeration of two or more individual particles.

The amount of photothermally active material used in the curable film-forming composition can vary. For example, the curable film-forming composition can comprise 0.001 to 10 percent by weight photothermally active material, with minimums, for example, of 0.001 percent by weight, or 0.01 percent by weight, or 0.02 percent by weight, and maximums of 10 percent by weight, or 2 percent by weight. Exemplary ranges include 0.01 to 2 percent by weight, 0.02 to 1.0 percent by weight, 0.05 to 0.5 percent by weight and 0.05 to 0.1 percent by weight, with percent by weight based on the total weight of all solids, including pigments, in the curable film-forming composition.

The curable film-forming compositions of the present invention may further comprise (d) a catalyst component. As used herein, the term “catalyst” refers to a substance that initiates and/or increases the rate of the curing reaction. The catalyst may include metal catalyst, amine catalyst, acid catalyst, ionic liquid catalyst or a combination thereof, as well as other catalysts known in the art. Non-limiting examples of catalysts that are suitable for use with the present invention include those formed from tin, cobalt, calcium, cesium, zinc, zirconium, bismuth, and aluminum as well as metal salts of carboxylic acids, diorganometallic oxides, mono- and diorganometallic carboxylates, and the like. The metal catalyst may also comprise calcium naphthanate, cesium naphthanate, cobalt naphthanate, dibutyl tin dilaurate, dibutyl tin diacetate, dibutyl tin dioctoate, or dibutyl tin naphthanate. Suitable amine catalysts include, for example, tertiary amine catalysts, including but not limited to triethylamine, 1,4-diazabicyclo[2.2.2]octane, 1,8-diazabicyclo[5.4.0]undec-7-ene, and N-ethylmorpholine. The catalyst may additionally be “blocked”, for example, with an acid or thiol, as is known in the art to further inhibit its activity until desired. Appropriate catalysts may be selected to effect reaction between specific functional groups as known in the art. For example, when the composition of the present invention includes aminoplast curing agents, catalysts including acid functional catalysts known to those skilled in the art as useful in aminoplast-cured compositions, such as para-toluenesulfonic acid, dodecylbenzene sulfonic acid, and the like, may be included.

When the catalyst component is absent from the curable film-forming composition, often the curable film-forming composition is essentially free of epoxide functional materials. Thus the curable film-forming composition of the present invention may be free of catalysts and epoxide functional materials.

The curable film-forming compositions of the present invention may be provided and stored as one-package compositions prior to use. A one-package composition will be understood as referring to a composition wherein all the coating components are maintained in the same container after manufacture, during storage, etc. The term “multi-package coatings” means coatings in which various components are maintained separately until just prior to application. The present coatings can also be multi-package coatings, such as a two-package coating. When the composition is a multi-package system, the photothermally active material (c) may be present in either one or both of the separate components (a) and (b) and/or as an additional separate component package.

The curable film-forming composition of the present invention may additionally include optional ingredients commonly used in such compositions. For example, the composition may further comprise a hindered amine light stabilizer for UV degradation resistance. Such hindered amine light stabilizers include those disclosed in U.S. Pat. No. 5,260,135. When they are used they are present in the composition in an amount of 0.1 to 2 percent by weight, based on the total weight of resin solids in the film-forming composition. Other optional additives may be included such as colorants, plasticizers, abrasion-resistant particles, film strengthening particles, flow control agents, thixotropic agents, rheology modifiers, fillers, antioxidants, biocides, defoamers, surfactants, wetting agents, dispersing aids, adhesion promoters, UV light absorbers and stabilizers, a stabilizing agent, organic cosolvents, reactive diluents, grind vehicles, and other customary auxiliaries, or combinations thereof. The term “colorant”, as used herein is as defined in U.S. Patent Publication No. 2012/0149820, paragraphs 29 to 38, the cited portion of which is incorporated herein by reference.

An “abrasion-resistant particle” is one that, when used in a coating, will impart some level of abrasion resistance to the coating as compared with the same coating lacking the particles. Suitable abrasion-resistant particles include organic and/or inorganic particles. Examples of suitable organic particles include, but are not limited to, diamond particles, such as diamond dust particles, and particles formed from carbide materials; examples of carbide particles include, but are not limited to, titanium carbide, silicon carbide and boron carbide. Examples of suitable inorganic particles, include but are not limited to silica; alumina; alumina silicate; silica alumina; alkali aluminosilicate; borosilicate glass; nitrides including boron nitride and silicon nitride; oxides including titanium dioxide and zinc oxide; quartz; nepheline syenite; zircon such as in the form of zirconium oxide; buddeluyite; and eudialyte. Particles of any size can be used, as can mixtures of different particles and/or different sized particles. For example, the particles can be microparticles, having an average particle size of 0.1 to 50, 0.1 to 20, 1 to 12, 1 to 10, or 3 to 6 microns, or any combination within any of these ranges. The particles can be nanoparticles, having an average particle size of less than 0.1 micron, such as 0.8 to 500, 10 to 100, or 100 to 500 nanometers, or any combination within these ranges.

As used herein, the terms “adhesion promoter” and “adhesion promoting component” refer to any material that, when included in the composition, enhances the adhesion of the coating composition to a metal substrate. Such an adhesion promoting component often comprises a free acid. As used herein, the term “free acid” is meant to encompass organic and/or inorganic acids that are included as a separate component of the compositions as opposed to any acids that may be used to form a polymer that may be present in the composition. The free acid may comprise tannic acid, gallic acid, phosphoric acid, phosphorous acid, citric acid, malonic acid, a derivative thereof, or a mixture thereof. Suitable derivatives include esters, amides, and/or metal complexes of such acids. Often, the free acid comprises a phosphoric acid, such as a 100 percent orthophosphoric acid, superphosphoric acid or the aqueous solutions thereof, such as a 70 to 90 percent phosphoric acid solution.

In addition to or in lieu of such free acids, other suitable adhesion promoting components are metal phosphates, organophosphates, and organophosphonates. Suitable organophosphates and organophosphonates include those disclosed in U.S. Pat. No. 6,440,580 at column 3, line 24 to column 6, line 22, U.S. Pat. No. 5,294,265 at column 1, line 53 to column 2, line 55, and U.S. Pat. No. 5,306,526 at column 2, line 15 to column 3, line 8, the cited portions of which are incorporated herein by reference. Suitable metal phosphates include, for example, zinc phosphate, iron phosphate, manganese phosphate, calcium phosphate, magnesium phosphate, cobalt phosphate, zinc-iron phosphate, zinc-manganese phosphate, zinc-calcium phosphate, including the materials described in U.S. Pat. Nos. 4,941,930, 5,238,506, and 5,653,790. As noted above, in certain situations, phosphates are excluded.

The adhesion promoting component may comprise a phosphatized epoxy resin. Such resins may comprise the reaction product of one or more epoxy-functional materials and one or more phosphorus-containing materials. Non-limiting examples of such materials, which are suitable for use in the present invention, are disclosed in U.S. Pat. No. 6,159,549 at column 3, lines 19 to 62, the cited portion of which is incorporated by reference herein.

The curable film-forming composition of the present invention may also comprise alkoxysilane adhesion promoting agents, for example, acryloxyalkoxysilanes, such as γ-acryloxypropyltrimethoxysilane and methacrylatoalkoxysilane, such as γ-methacryloxypropyltrimethoxysilane, as well as epoxy-functional silanes, such as γ-glycidoxypropyltrimethoxysilane. Exemplary suitable alkoxysilanes are described in U.S. Pat. No. 6,774,168 at column 2, lines 23 to 65, the cited portion of which is incorporated by reference herein.

The adhesion promoting component is usually present in the coating composition in an amount ranging from 0.05 to 20 percent by weight, such as at least 0.05 percent by weight or at least 0.25 percent by weight, and at most 20 percent by weight or at most 15 percent by weight, with ranges such as 0.05 to 15 percent by weight, 0.25 to 15 percent by weight, or 0.25 to 20 percent by weight, with the percentages by weight being based on the total weight of resin solids in the composition.

The coating compositions of the present invention may also comprise, in addition to any of the previously described corrosion resisting particles, conventional non-chrome corrosion resisting particles. Suitable conventional non-chrome corrosion resisting particles include, but are not limited to, iron phosphate, zinc phosphate, calcium ion-exchanged silica, colloidal silica, synthetic amorphous silica, and molybdates, such as calcium molybdate, zinc molybdate, barium molybdate, strontium molybdate, and mixtures thereof. Suitable calcium ion-exchanged silica is commercially available from W. R. Grace & Co. as SHIELDEX. AC3 and/or SHIELDEX. C303. Suitable amorphous silica is available from W. R. Grace & Co. as SYLOID. Suitable zinc hydroxyl phosphate is commercially available from Elementis Specialties, Inc. as NALZIN. 2. These conventional non-chrome corrosion resisting pigments typically comprise particles having a particle size of approximately one micron or larger. These particles may be present in the coating compositions of the present invention in an amount ranging from 5 to 40 percent by weight, such as at least 5 percent by weight or at least 10 percent by weight, and at most 40 percent by weight or at most 25 percent by weight, with ranges such as 10 to 25 percent by weight, with the percentages by weight being based on the total solids weight of the composition.

The present coatings may also comprise one or more organic inhibitors. Examples of such inhibitors include but are not limited to sulfur and/or nitrogen containing heterocyclic compounds, examples of which include thiophene, hydrazine and derivatives, pyrrole and derivatives. When used, organic inhibitors may be present in the coating compositions in an amount ranging from 0.1 to 20 percent by weight, such as 0.5 to 10 percent by weight, with weight percentages being based on the total solids weight of the composition.

The present invention further provides a substrate at least partially coated with any of the curable film-forming compositions described above. A typical coated substrate comprises A) a substrate having at least one coatable surface, and B) a curable film-forming composition, including any of those described above, applied to at least one surface of the substrate.

Substrates include, for example, automotive substrates, industrial substrates, packaging substrates, wood flooring and furniture, apparel, electronics including housings and circuit boards, glass and transparencies, sports equipment including golf balls, and the like. These substrates can be, for example, metallic or non-metallic. The substrate can be one that has been already treated in some manner, such as to impart visual and/or color effect.

Non-metallic substrates including polymeric, plastic, polyester, polyolefin, polyamide, cellulosic, polystyrene, polyacrylic, poly(ethylene naphthalate), polypropylene, polyethylene, nylon, EVOH, poly(lactic acid), other “green” polymeric substrates, poly(ethylene terephthalate) (“PET”), polycarbonate, polycarbonate acrylonitrile butadiene styrene (“PC/ABS”), polyamide, polymer composites, wood, veneer, wood composite, particle board, medium density fiberboard, cement, stone, glass, paper, cardboard, textiles, leather, both synthetic and natural, and the like.

The metal substrates used in the present invention include ferrous metals, non-ferrous metals and combinations thereof. Suitable ferrous metals include iron, steel, and alloys thereof. Non-limiting examples of useful steel materials include cold rolled steel, pickled steel, steel surface-treated with any of zinc metal, zinc compounds and zinc alloys (including electrogalvanized steel, hot-dipped galvanized steel, GALVANNEAL steel, and steel plated with zinc alloy,) and/or zinc-iron alloys. Also, aluminum, aluminum alloys, zinc-aluminum alloys such as GALFAN, GALVALUME, aluminum plated steel and aluminum alloy plated steel substrates may be used, as well as magnesium metal, titanium metal, and alloys thereof. Steel substrates (such as cold rolled steel or any of the steel substrates listed above) coated with a weldable, zinc-rich or iron phosphide-rich organic coating are also suitable for use in the present invention. Such weldable coating compositions are disclosed in U.S. Pat. Nos. 4,157,924 and 4,186,036. Cold rolled steel is also suitable when pretreated with an appropriate solution known in the art, such as a metal phosphate solution, an aqueous solution containing at least one Group IIIB or IVB metal, an organophosphate solution, an organophosphonate solution, and combinations thereof, as discussed below.

The substrate may alternatively comprise more than one metal or metal alloy in that the substrate may be a combination of two or more metal substrates assembled together such as hot-dipped galvanized steel assembled with aluminum substrates. The substrate may comprise part of a vehicle. “Vehicle” is used herein in its broadest sense and includes all types of vehicles, such as but not limited to airplanes, helicopters, cars, trucks, buses, vans, golf carts, motorcycles, bicycles, railroad cars, tanks and the like. It will be appreciated that the portion of the vehicle that is coated according to the present invention may vary depending on why the coating is being used. Often the substrate is an automobile part.

The curable film-forming composition may be applied directly to the substrate when there is no intermediate coating between the substrate and the curable film-forming composition. By this is meant that the substrate may be bare, as described below, or may be treated with one or more pretreatment compositions as described below, but the substrate is not coated with any coating compositions such as an electrodepositable composition or a primer composition prior to application of the curable film-forming composition of the present invention.

As noted above, the substrates to be used may be bare substrates. By “bare” is meant a virgin substrate that has not been treated with any pretreatment compositions such as conventional phosphating baths, heavy metal rinses, etc. Additionally, bare metal substrates being used in the present invention may be a cut edge of a substrate that is otherwise treated and/or coated over the rest of its surface. Alternatively, the substrates may undergo one or more treatment steps known in the art prior to the application of the curable film-forming composition.

The substrate may optionally be cleaned using conventional cleaning procedures and materials. These would include mild or strong alkaline cleaners such as are commercially available and conventionally used in metal pretreatment processes. Examples of alkaline cleaners include Chemkleen 163 and Chemkleen 177, both of which are available from PPG Industries, Pretreatment and Specialty Products. Such cleaners are generally followed and/or preceded by a water rinse. The metal surface may also be rinsed with an aqueous acidic solution after or in place of cleaning with the alkaline cleaner. Examples of rinse solutions include mild or strong acidic cleaners such as the dilute nitric acid solutions commercially available and conventionally used in metal pretreatment processes. Rinse solutions containing heavy metals such as chromium are not suitable for use in the process of the present invention.

The metal substrate may optionally be pretreated with any suitable solution known in the art, such as a metal phosphate solution, an aqueous solution containing at least one Group IIIB or IVB metal, an organophosphate solution, an organophosphonate solution, and combinations thereof. The pretreatment solutions may be essentially free of environmentally detrimental heavy metals such as chromium and nickel. Suitable phosphate conversion coating compositions may be any of those known in the art that are free of heavy metals. Examples include zinc phosphate, which is used most often, iron phosphate, manganese phosphate, calcium phosphate, magnesium phosphate, cobalt phosphate, zinc-iron phosphate, zinc-manganese phosphate, zinc-calcium phosphate, and layers of other types, which may contain one or more multivalent cations. Phosphating compositions are known to those skilled in the art and are described in U.S. Pat. Nos. 4,941,930, 5,238,506, and 5,653,790.

The IIIB or IVB transition metals and rare earth metals referred to herein are those elements included in such groups in the CAS Periodic Table of the Elements as is shown, for example, in the Handbook of Chemistry and Physics, 63rd Edition (1983).

Typical group IIIB and IVB transition metal compounds and rare earth metal compounds are compounds of zirconium, titanium, hafnium, yttrium and cerium and mixtures thereof. Typical zirconium compounds may be selected from hexafluorozirconic acid, alkali metal and ammonium salts thereof, ammonium zirconium carbonate, zirconyl nitrate, zirconium carboxylates and zirconium hydroxy carboxylates such as hydrofluorozirconic acid, zirconium acetate, zirconium oxalate, ammonium zirconium glycolate, ammonium zirconium lactate, ammonium zirconium citrate, and mixtures thereof. Hexafluorozirconic acid is used most often. An example of a titanium compound is fluorotitanic acid and its salts. An example of a hafnium compound is hafnium nitrate. An example of a yttrium compound is yttrium nitrate. An example of a cerium compound is cerous nitrate.

Typical compositions to be used in the pretreatment step include non-conductive organophosphate and organophosphonate pretreatment compositions such as those disclosed in U.S. Pat. Nos. 5,294,265 and 5,306,526. Such organophosphate or organophosphonate pretreatments are available commercially from PPG Industries, Inc. under the name NUPAL®.

The coating compositions of the present invention may be applied to a substrate by known application techniques, such as dipping or immersion, spraying, intermittent spraying, dipping followed by spraying, spraying followed by dipping, brushing, or by roll-coating. Usual spray techniques and equipment for air spraying and electrostatic spraying, either manual or automatic methods, can be used.

After application of the composition to the substrate, a film is formed on the surface of the substrate by driving solvent, i.e., organic solvent and/or water, out of the film by heating or by an air-drying period. Suitable drying conditions will depend on the particular composition and/or application, but in some instances a drying time of from about 1 to 5 minutes at a temperature of about 70 to 250° F. (27 to 121° C.) will be sufficient. More than one coating layer of the present composition may be applied if desired. Usually between coats, the previously applied coat is flashed; that is, exposed to ambient conditions for the desired amount of time. The thickness of the coating is usually from 0.1 to 3 mils (2.5 to 75 microns), such as 0.2 to 2.0 mils (5.0 to 50 microns).

The coated substrate may then be irradiated with pulsed actinic radiation at a wavelength, duration, and intensity sufficient to at least partially cure the curable film-forming composition. In the curing operation, reactive functional groups on the components of the composition are crosslinked. Actinic radiation which can be used to cure coating compositions of the present invention generally has wavelengths of electromagnetic radiation ranging from 150 to 2,000 nanometers (nm), can range from 180 to 1,000 nm, and also can range from 300 to 1000 nm. Examples of suitable ultraviolet light sources include mercury arcs, carbon arcs, low, medium or high pressure mercury lamps, swirl-flow plasma arcs and ultraviolet light emitting diodes. Commonly used ultraviolet light-emitting lamps are medium pressure mercury vapor lamps having outputs ranging from 200 to 600 watts per inch (79 to 237 watts per centimeter) across the length of the lamp tube. Generally, a 1 mil (25 micrometers) thick wet film of a coating composition according to the present invention can be cured through its thickness to a tack-free state upon exposure to actinic radiation of wavelength 300 to 1000 nm. The typical duration of an actinic radiation pulse is from femtoseconds to microseconds, such as 1 femtosecond to 1 microsecond and the total exposure time to the pulsed radiation may range from microseconds to days, such as 1 microsecond to 48 hours. An intensity of 1 to 10⁸ Watts per square centimeter of the wet film is typical. Particular exposure conditions are dependent upon the identity of the photothermally active material; i.e., the known light wavelength and intensity for maximum heat emission for a given photothermally active material.

Each of the characteristics and examples described above, and combinations thereof, may be said to be encompassed by the present invention. The present invention is thus drawn to the following nonlimiting aspects: in a first aspect, a curable film-forming composition is provided by the present invention, comprising: (a) a curing agent having reactive functional groups and comprising a polyisocyanate, beta-hydroxyalkylamide, polyacid, organometallic acid-functional material, polyamine, polyamide, polysulfide, polythiol, polyene, polyol, polysilane and/or an aminoplast; (b) a compound having functional groups reactive with the reactive functional groups in (a) and comprising an addition polymer, a polyether polymer, a polyester polymer, a polyester acrylate polymer, a polyurethane polymer, and/or a polyurethane acrylate polymer; and (c) a photothermally active material.

In a second aspect, a curable film-forming composition is provided by the present invention, comprising: (a) a curing agent having reactive functional groups; (b) a compound comprising functional groups reactive with the reactive functional groups in (a); (c) a photothermally active material; and (d) a catalyst component.

In a third aspect, in any of the compositions according to either of the first or second aspect described above, the functional groups on the compound (b) are selected from carboxylic acid groups, amine groups, hydroxyl groups, thiol groups, carbamate groups, amide groups, urea groups, (meth)acrylate groups, styrenic groups, vinyl groups, allyl groups, aldehyde groups, acetoacetate groups, hydrazide groups, cyclic carbonate, acrylate, maleic and mercaptan groups.

In a fourth aspect, in any of the compositions according to any aspect described above, the photothermally active material (c) comprises silver, gold, aluminum, copper, titanium, chromium, magnetite, Si, Ge, Sn, GaAs, CdSe, AlGaAs, Fe4[Fe(CN)6]3, Cu-phthalocyanine, HgS, a metal oxide, carbon, an organic dye, polythiophene, polyacetylene, and/or polyaniline.

In a fifth aspect, in any of the compositions according to any aspect described above, the composition is a two-package composition, and the photothermally active material (c) is present with the curing agent (a) in a first package and/or with the compound (b) in a second package.

In a sixth aspect, in any of the compositions according to the first aspect described above, the composition is free of epoxide functional materials.

In a seventh aspect, a coated substrate is provided, at least partially coated with any of the curable film-forming compositions according to any of the first through sixth aspects above.

In an eighth aspect, a coated substrate is provided according to any of the fifth through seventh aspects above, wherein the substrate is an automobile part.

In a ninth aspect, a method of coating a substrate is provided, comprising: (1) applying to at least one surface of the substrate a curable film-forming composition to form a coated substrate, wherein the curable film-forming composition comprises any of the curable film-forming compositions according to any of the first through sixth aspects above; and (2) irradiating the coated substrate with pulsed actinic radiation at a wavelength, duration, and intensity sufficient to at least partially cure the curable film-forming composition.

In a tenth aspect, a method of coating a substrate is provided according to the ninth aspect above, wherein the substrate is in the form of an automobile part.

In an eleventh aspect, a method of coating a substrate is provided according to either of the ninth or tenth aspect above, wherein the wavelength of actinic radiation is from 300 to 1000 nm.

In a twelfth aspect, a method of coating a substrate is provided according to any of the ninth through eleventh aspects above, wherein the duration of an actinic radiation pulse is from 1 femtosecond to 1 microsecond and the total duration of exposure to pulsed irradiation ranges from 1 microsecond to 48 hours.

In a thirteenth aspect, a method of coating a substrate is provided according to any of the ninth through twelfth aspects above, wherein intensity of actinic radiation is from 1 to 10⁸ W/cm².

The invention will be further described by reference to the following examples. Unless otherwise indicated, all parts are by weight.

### Examples

This example demonstrates the preparation of polyurethane films from hexamethylene diisocyanate (HDI—formulated as Desmodur N3600, available from Bayer MaterialScience), and the diester polyol poly-bis(triethylol) heptanedioate (BTEH—formulated as K-FLEX-188, available from King Industries Specialty Chemicals.) For this study, octanethiol-protected gold nanoparticles (AuNPs) with diameters of ˜2 nm were used. These particles are near the smallest that support a SPR and thus have the desired photophysical properties that lead to the photothermal effect. Though larger particles would possess a stronger SPR (and associated photothermal effect), small particles were chosen for the kinetics of thermal diffusion. The smaller the particle, the faster the quenching of the temperatures, and the more likely to trap transiently formed chemical bonds. For 2 nm AuNPs, the decay of the temperature is on the order of 10 ps,⁴ and can compete with the kinetics of bond formation/cleavage.

The appropriate solutions were made by mixing HDI and BTEH in an approximately 1:1 ratio with either pure toluene, or toluene solutions containing either AuNPs or DBTDL, or both. In all cases containing AuNPs or DBTDL, the final concentrations of these additives were 0.08% w/v and 0.07% w/v, respectively. These concentrations were chosen based upon preliminary data, such that the action of the photothermal effect would be comparable to the action of the catalyst. The final concentration of isocyanate was 13.7 M, which is similar to that used in industrial applications of urethane films.

After the solutions were prepared, the reaction between HDI and BTEH was allowed to proceed for four minutes, either in the presence or absence of light. For those exposed to light, 8 ns pulses (50 mJ per pulse) of 532 nm light were generated from a QuantaRay 130 Nd:YAG laser operating at a repetition rate of 10 Hz. The peak irradiance for these pulses is 12.5 MW cm⁻². The polymerization of isocyanate and polyol to polyurethane was monitored following the disappearance of the free isocyanate peak at 2274 cm⁻¹.

All conditions gave rise to linear early kinetics, and so comparisons between the various conditions are in terms of the initial rates of reaction. Using these rates, the relative enhancement of bond formation was calculated for each condition, by dividing the rate for each condition by the rate of the pure polymer film in the dark (condition i, as a control). The enhancement factors are shown in Table 1.

There are a number of interesting results that are apparent from inspection of Table 1. Only samples containing AuNPs experience rate enhancement upon exposure to light. These results imply that the AuNPs are the only significant source of photothermal heating—an important result given that DBTDL is a slightly colored compound. It also implies that any increase in reaction rate upon exposure to light must stem from the actions of AuNPs.

In addition, the photothermal enhancement for films with only AuNPs is comparable to the rate enhancement for films with only catalysts, which means that the photothermal effect of AuNPs competes on a weight-by-weight basis with the action of traditional catalysts. However, considering the action on a per-number basis, the relative mass difference between the catalytic molecules (631.56 g/mol) and the AuNPs (˜3.9×10⁴ g/mol) implies that, on a per-number basis, the photothermal effect of gold is approximately 90 times more efficient at accomplishing urethane formation than is the catalytic effect of DBTDL. Here it is important to realize that the molecular mass given for AuNPs is only a rough estimation based upon the mean size of a polydisperse sample. The greater effectiveness per AuNP was an anticipated result, as the AuNP is able to create an area effect, while the catalyst interacts on a one-to-one basis with its substrate.

There is also a synergistic effect between the action of the DBTDL and the photothermal effect of the gold nanoparticles. That is, the enhancement of the rate is not the simple addition of the enhancements for DBTDL and AuNPs alone. Importantly, without light, the samples with DBTDL alone and DBTDL+AuNPs experience the same rate—meaning that the presence of AuNPs is not sufficient for this synergy; instead the SPR of the AuNP must be excited. In addition, irradiation of DBTDL produces no enhancement relative to the action of DBTDL alone. Thus, the large synergy must result from the excitation of the AuNPs' SPR in the presence of DBTDL. This conclusion implies that there is some interaction between DBTDL and the AuNPs, during irradiation, though the exact nature of this interaction in not clear at this time. Possible sources of synergy could be increased mobility of the liquid components, which would facilitate the diffusion-limited action of the catalyst. In addition, it is known that HDI exists (in part) as a trimer, joined at the isocyanate moieties. This trimer must be broken before the isocyanates are free to react with alcohols. Thus, if the photothermal effect results in the breaking of the trimer, this would make more free isocyanates available the DBTDL—providing another mechanism for synergy.

In order to ensure that the rate enhancements observed for the photothermal effect were not merely a result of bulk-scale temperature increases, the temperature changes were measured during the course of the reaction under all eight conditions reported. This was done using an IR thermal imager (Raytek ThermoView Ti30) to acquire temperature measurements before and after 4 minutes. A summary of the observed temperature changes (ΔT_{obs}) are given in Table 1. As can be seen, the only conditions that led to an observable temperature increase were those in which AuNPs were exposed to laser light. However, in these cases, the bulk-temperature jump was far too small (on the order of 10 K) to account for the observed rate increases. This point was confirmed by following the kinetics of polymer formation under several temperatures, attained by bulk heating in an oil bath (supporting information). These results indicate that bulk temperature changes (ΔT_{kinetics}) of ca. 65 K would be needed in order to observe the kinetic enhancement achieved by the photothermally driven reactions. Thus, the observed photothermal enhancement is not an effect of simple bulk-scale heating, but the result of transient and intense heat produced near the AuNPs' surface. The above conclusion—that it is the localized and transient heat that gives rise to the rate enhancement—carries with it several additional implications. First, this implies that the reaction rate is only increased while the AuNP is hot. Given the fast rise and decay of the temperature for these particles, it can be approximated that the particles are only hot for the duration of the laser pulse (8 ns)—or a total of ca. 2 ps during the course of the 4 minute experiments. Recalculating the rate of reaction using the total irradiation time (Table 1), shows an astonishing enhancement of reaction rate on the order of billion-fold. Here it is important to note that this is the calculated increase in the rate of reaction during the time that the particles are hot—not the steady state rate for the full 4 minute time period.

The rate adjusted for irradiation time further implies a temperature of at least 600 K—though the actual temperature near the nanoparticle surface must be many times higher. Again, given the energetics of this reaction, the equilibrium should lie far to the side of the reactants at these temperatures and so the observed completion percentage must result from the trapping of transiently formed bonds during the thermal quenching of the particles. This conclusion highlights the unique ability to quickly drive bond formation at ‘effective’ temperatures that are far higher than those that would otherwise fail to give rise to appreciable reaction progress.

These considerations further emphasize the benefits of photothermal heating over traditional catalysts, such as DBTDL. Unlike traditional catalysts, the efficiency of the AuNPs should be easily and dynamically tunable via alteration of the conditions. Indeed, increasing either the irradiance or the repetition rate of the laser should give rise to an increase in the efficacy of the photothermal effect. Simple consideration of the timescales associated with the photothermal effect suggests a further million-fold increase in repetition rate could be applied, while still realizing gains in efficacy. In total, use of the photothermal effect provides the possibility of dynamic tuning of the reaction rate over 12 orders of magnitude.

TABLE 1
Summary of initial rate of reaction, enhancements, observed
temperature changes, anticipated tempterature changes, and
equilibrium constants for the anticipated temperatures for
all eight conditions (see Key, FIG. 1). Shows the the results
caculated for real time and irradiated time.

| | | | |
|---|---|---|---|
| | En- | | |
| Condition | hancement | ΔT_{obs} | ΔT_{kinetics} |

Real Time

| | | | | | |
|---|---|---|---|---|---|
| HDI + BTEH | no light | i | 1 | 0 | 0 |
| | light | ii | 1 | 0 | 0 |
| HDI + BTEH + AuNP | no light | iii | 2 | 0 | 0 |
| | light | iv | 15 | 12 | 65 |
| HDI + BTEH + DBTDL | no light | v | 11 | 0 | 0 |
| | light | vi | 12 | 0 | 0 |
| HDI + BTEH + | no light | vii | 10 | 0 | 0 |
| AuNP + DBTDL | light | viii | 49 | 8 | 65 |

Irradiated Time

| | | | | | |
|---|---|---|---|---|---|
| HDI + BTEH + AuNP | light | iv | 1.55 × 10⁹ | 12 | 305 |
| HDI + BTEH + | light | viii | 4.84 × 10⁹ | 8 | 322 |
| AuNP + DBTDL | | | | | |

Therefore, we claim:

1. A curable film-forming composition comprising:
(a) a curing agent having reactive functional groups and comprising a polyisocyanate, beta-hydroxyalkylamide, polyacid, organometallic acid-functional material, polyamine, polyamide, polysulfide, polythiol, polyene, polyol, polysilane and/or an aminoplast;
(b) a compound having functional groups reactive with the reactive functional groups in (a) and comprising an addition polymer, a polyether polymer, a polyester polymer, a polyester acrylate polymer, a polyurethane polymer, and/or a polyurethane acrylate polymer; and
(c) a photothermally active material.

2. The composition of claim 1, wherein the functional groups on the compound (b) are selected from carboxylic acid groups, amine groups, hydroxyl groups, thiol groups, carbamate groups, amide groups, urea groups, (meth)acrylate groups, styrenic groups, vinyl groups, allyl groups, aldehyde groups, acetoacetate groups, hydrazide groups, cyclic carbonate, acrylate, maleic and mercaptan groups.

3. The composition of claim 1, wherein the photothermally active material (c) comprises silver, gold, aluminum, copper, titanium, chromium, magnetite, Si, Ge, Sn, GaAs, CdSe, AlGaAs, Fe4[Fe(CN)6]3, Cu-phthalocyanine, HgS, a metal oxide, carbon, an organic dye, polythiophene, polyacetylene, and/or polyaniline.

4. The composition of claim 1, wherein the composition is a two-package composition, and the photothermally active material (c) is present with the curing agent (a) in a first package and/or with the compound (b) in a second package.

5. The composition of claim 1, further comprising (d) a catalyst component.

6. The composition of claim 1, wherein said composition is free of epoxide functional materials.

7. A coated substrate comprising:
A) a substrate having at least one coatable surface, and
B) a curable film-forming composition applied to at least one surface of the substrate, wherein the film-forming composition is prepared from the curable composition of claim 1.

8. A curable film-forming composition comprising:
(a) a curing agent comprising reactive functional groups;
(b) a compound comprising functional groups reactive with the reactive functional groups in (a);
(c) a photothermally active material; and
(d) a catalyst component.

9. The composition of claim 8, wherein the curing agent (a) comprises a polyisocyanate, polyepoxide, beta-hydroxyalkylamide, polyacid, organometallic acid-functional material, polyamine, polyamide, polysulfide, polythiol, polyene, polyol, polysilane and/or an aminoplast.

10. The composition of claim 8, wherein the compound (b) comprises an addition polymer, a polyepoxide polymer, a polyether polymer, a polyester polymer, a polyester acrylate polymer, a polyurethane polymer, and/or a polyurethane acrylate polymer.

11. The composition of claim 8, wherein the functional groups on the compound (b) are selected from carboxylic acid groups, amine groups, epoxide groups, hydroxyl groups, thiol groups, carbamate groups, amide groups, urea groups, (meth)acrylate groups, styrenic groups, vinyl groups, allyl groups, aldehyde groups, acetoacetate groups, hydrazide groups, cyclic carbonate, acrylate, maleic and mercaptan groups.

12. The composition of claim 8, wherein the photothermally active material (c) comprises silver, gold, aluminum, copper, titanium, chromium, magnetite, Si, Ge, Sn, GaAs, CdSe, AlGaAs, Fe4[Fe(CN)6]3, Cu-phthalocyanine, HgS, a metal oxide, carbon, an organic dye, polythiophene, polyacetylene, and/or polyaniline.

13. The composition of claim 8, wherein the composition is a two-package composition, and the photothermally active material (c) is present with the curing agent (a) in a first package and/or with the compound (b) in a second package.

14. A coated substrate comprising:
A) a substrate having at least one coatable surface, and
B) a curable film-forming composition applied to at least one surface of the substrate, wherein the film-forming composition is prepared from the curable composition of claim 8.

15. A method of coating a substrate, comprising:
(1) applying to at least one surface of the substrate a curable film-forming composition to form a coated substrate, wherein the curable film-forming composition comprises:
(a) a curing agent having reactive functional groups and comprising a polyisocyanate, beta-hydroxyalkylamide, polyacid, organometallic acid-functional material, polyamine, polyamide, polysulfide, polythiol, polyene, polyol, polysilane and/or an aminoplast;
(b) a compound having functional groups reactive with the reactive functional groups in (a) and comprising an addition polymer, a polyether polymer, a polyester polymer, a polyester acrylate polymer, a polyurethane polymer, and/or a polyurethane acrylate polymer; and
(c) a photothermally active material; and
(2) irradiating the coated substrate with pulsed actinic radiation at a wavelength, duration, and intensity sufficient to at least partially cure the curable film-forming composition.

16. The method of claim 15, wherein the curable film-forming composition is a two-package composition, and the photothermally active material (c) is present with the curing agent (a) in a first package and/or with the compound (b) in a second package.

17. The method of claim 15, wherein the curable film-forming composition further comprises (d) a catalyst component.

18. The method of claim 15, wherein the wavelength of actinic radiation is from 300 to 1000 nm.

19. The method of claim 15, wherein the duration of an actinic radiation pulse is from 1 femtosecond to 1 microsecond and the total duration of exposure to irradiation pulses ranges from 1 microsecond to 48 hours.

20. The method of claim 15, wherein the intensity of actinic radiation is from 1 to 10⁸ W/cm².

21. A method of coating a substrate, comprising:
(1) applying to at least one surface of the substrate a curable film-forming composition to form a coated substrate, wherein the curable film-forming composition comprises:
(a) a curing agent comprising reactive functional groups;
(b) a film-forming compound comprising functional groups reactive with the reactive functional groups in (a); and
(c) a photothermally active material, and
(d) a catalyst component; and
(2) irradiating the coated substrate with pulsed actinic radiation at a wavelength, duration, and intensity sufficient to at least partially cure the curable film-forming composition.

22. The method of claim 21, wherein the curable film-forming composition is a two-package composition, and the photothermally active material (c) is present with the curing agent (a) in a first package and/or with the film-forming compound (b) in a second package.

23. The method of claim 21, wherein the wavelength of actinic radiation is from 300 to 1000 nm.

24. The method of claim 21, wherein the duration of an actinic radiation pulse is from 1 femtosecond to 1 microsecond and the total duration of exposure to irradiation pulses ranges from 1 microsecond to 48 hours.

25. The method of claim 21, wherein the intensity of actinic radiation is from 1 to 10⁸ W/cm².
